(19) United States
(12) Patent Application Publication
(10) Pub. No.: US 2014/0143401 A1
(43) Pub. Date: May 22, 2014

(54) Systems and Methods for Implementing Cloud Computing

(71) Applicant: Nebula, Inc., Mountain View, CA (US)

(72) Inventors: Devin C. Carlen, Seattle, WA (US); Mark Anthony Gius, Seattle, WA (US); Joseph F. Heck, Seattle, WA (US); Tres L. Henry, Seattle, WA (US); Chris C. Kemp, Belmont, CA (US); Jon E. Mittelhauser, Monte Sereno, CA (US); Michael Alexander Szilagyi, Seattle, WA (US); Jeffrey J. Ward, Oakland, CA (US)

(73) Assignee: Nebula, Inc., Mountain View, CA (US)

(21) Appl. No.: 14/163,194

(22) Filed: Jan. 24, 2014

Related U.S. Application Data
(63) Continuation of application No. PCT/US12/48412, filed on Jul. 26, 2012.
(60) Provisional application No. 61/511,966, filed on Jul. 26, 2011.

(51) Int. Cl. H04L 12/26

(52) U.S. Cl. CPC H04L 43/10
USPC 709/223

(57) ABSTRACT

The disclosed implementations include a hardware appliance and method of using that appliance that may be configured to be coupled with commodity server nodes to provide a fault tolerant and available private cloud. The implementations can use a host for software containers and a switch to communicate with external networks and cloud nodes. Thus, this cloud controller appliance can provide a system to deploy a private cloud within an enterprise.

### REFERENCE TO RELATED CASES

This patent application claims priority from and is related to International application no. PCT/US12/48412 filed Jul. 26, 2012, which claims priority from US provisional application No. 61/511,966 filed Jul. 26, 2011, which are hereby incorporated by reference in their entirety.

### TECHNICAL FIELD

The technology described in this patent document relates to cloud computing, specifically, implementing privatized clouds.

### BACKGROUND

Cloud computing deals with computer networks established to allow users remote access to computing infrastructure. In this way, users do not have to purchase and operate infrastructure on site, rather, they are allowed to purchase the use of infrastructure that resides somewhere else on a network. In this way, users can utilize an elastic infrastructure.

Private and public cloud networks exist to provide varying levels of access. The decision of whether to use a private or public clouds is affected by the performance of each.

### SUMMARY

As described herein, the disclosed implementations provide many exemplary benefits, including, for example, enabling organizations to run big data workloads more economically, providing turnkey solutions requiring no development, integration, or consulting, providing private clouds that can be built using commodity hardware, thereby slashing costs, eliminating the need for enterprises to be locked into specific vendor solutions, instead allowing them to choose any compute and storage hardware needed, and easily swap in new hardware, enabling enterprises to spend less time and money on building and managing private clouds, leaving more resources available for running the business, and providing an open platform that allows providers to build new applications.

Open Source Private Cloud Platforms

Organizations want the flexibility that private clouds provide without the hardware and software compatibility problems, or the high price tag. In short, they want “Amazon Web Services (AWS) behind the firewall”—elastic, unlimited storage that remains fully controlled by the enterprise.

To bring about this vision, enterprises must be able to take advantage of affordable yet powerful commodity hardware, combined with open source solutions. Such a hardware and software combination needs to be easily managed by IT departments without the intervention of consultants, and should be based on easily replaceable components in case of failure.

Ideal private cloud platforms are scalable for big data, include pre-integrated with software and hardware, are inexpensive with low total cost of ownership, have excellent fault tolerance, and are secure and compliant.

Markets

The systems and methods disclosed herein may serve industries in which the ability to create and manage private clouds is critical to success, and can address many common challenges. For example, private clouds can be used in biotech/life sciences (shorten research cycles, reduce clinical trial expense and timelines, facilitate collaboration with researchers), financial services (conduct portfolio risk analysis, detect fraud), telecommunications (reduce customer churn, analyze social media and contact center data), retail (improve supply chain efficiency), consumer web environments (rapidly provision compute and storage resources, shorten software development lifecycle, analyze data to improve recommendation engines), and the like.

One example of the system may be described as a system configured to operate a private cloud computing network comprising, one or more hardware appliances each having at least one host and at least one switch, wherein at least one host is configured to run at least one software container and, and wherein at least one switch is configured to communicate with at least one cloud node and configured to communicate with at least one external network. Further, the one or more appliances are configured to maintain operation/availability of the cloud network. This is through its redundancy capabilities when networked, as described later.

In this example, one or more containers could be selected from the list of: a provisioning container, a logging container, a database container, a queue container, a DNS container, and a load balancer container.

Further, in this example, wherein the one or more appliances are grouped in one or more zones, the zones defining a cloud computing system, wherein the appliances in the zone are configured to be in communication with one anther over one or more of the following virtual local area networks: a management network, a guest instance network, and an external network, and wherein the appliances in the zone are configured to communicate to nodes internally via a provisioning network.

And this example system could further comprise a web-based user interface which is configured to manage each connected device and provide the status of those connected devices. This example appliance could have at least one container as an OpenStack container configured to run and/or manage the cloud network. It could also have the configuration to maintain operation/availability of the cloud network comprises monitoring the at least one appliance other via a heartbeat system and an orchestration manager, wherein the heartbeat system could include one or more components configured to communicate and/or perform status checks between appliances and/or containers and the orchestration manager to ensure proper operation.

This example system could have one or more appliances that each have the same containers for redundancy. And this system could have at least one of the one or more containers is an orchestration manager configured to: monitor the at least one appliance and the at least one container via the heartbeat system; and designate another container in a networked appliance, or another appliance, if the heartbeat system indicates the container or appliance is malfunctioning.

This example system could have one of the one or more containers in the host is a load balancer configured to balance loads across one or more containers from the one or more appliances. And at least one switch is configured to communicate with the at least one cloud node regarding at least one of the following tasks taken from the list of: virtual machine, storage, and computation; and send data to and receive data from at least one external network.

Another example way of how the appliance may communicate with the cloud nodes and the external network, is by receiving data requests, via at least one switch, from an external network, processing the received data requests in at least one or more software containers and, sending cloud node data requests, via at least one switch, to at least one cloud node, receiving cloud node data, via at least one switch, from at least one cloud node, processing the received cloud node data in the at least one or more software containers and, sending the processed data to the external network in response to the received data request. In this example, at least one appliance is configured to communicate with another appliance, or many appliances networked together, for example in a zone.

In this example method, at least one appliance is two or more networked appliances configured for redundancy, and wherein the redundancy includes hosting redundant containers in order to take over container tasks. Further, the back up could include an orchestration manager container configured to communicate with all of the networked appliance containers via a heartbeat system, wherein the orchestration manager container designates at least one redundant container in any networked appliance, to take over for at least one container that the heartbeat system indicates is malfunctioning.

Still referring to this example, the at least one container is a load balancer configured to assign tasks to at least one container, wherein the at least one container is hosted in either the same appliance as the load balancer, or another, networked appliance. And this method could have at least one container as an OpenStack container configured to manage the cloud network.

Again, in this example, at least one of the containers could be an orchestration manager container is configured to: receive heartbeat information from the at least one container; process the received heartbeat information; and designate at least one other container to replace a container if the heartbeat information indicates that the container is malfunctioning, wherein the at least one other container is found in any of the networked appliances.

And this could use networked appliances to communicate via one or more of the following virtual local area networks: a management network; a guest instance network; and an external service network, wherein each appliance communicates internally via a provisioning virtual local area network; and wherein the networked appliances are configured to communicate with an external network via an aggregation switch.

One final example could be A system configured to operate a private cloud computing network comprising: one or more of components and/or hardware appliances configured to: receive data requests, via at least one switch, from an external network; process the received data requests in at least one or more software containers; send cloud node data requests, via at least one switch, to at least one cloud node; receive cloud node data, via at least one switch, from at least one cloud node; process the received cloud node data in the at least one or more software containers; send the processed data to the external network in response to the received data request, wherein the at least one appliance is configured to connect with at least one other appliance.

This example system could have at least one of the containers as an orchestration manager container, configured to manage redundancy of the at least one container using a heartbeat system, wherein the heartbeat system comprises communications between the at least one container and the orchestration manager container regarding container performance, and wherein the orchestration manager is configured to replace a malfunctioning container with another container found on another appliance.

And this last example system could have at least one of the at containers as a load balancer, configured to balance loads across any container in any of the networked appliances.

### BRIEF DESCRIPTION OF THE DRAWINGS

For a better understanding of the implementations described in this application, reference should be made to the Detailed Description below, in conjunction with the following drawings in which like reference numerals refer to corresponding parts throughout the FIGS.

FIG. 1 illustrates recent data growth.

FIG. 2 illustrates some pros and cons of public vs. private clouds.

FIG. 3 illustrates an exemplary network configuration for implementing a private cloud according to disclosed implementations.

FIG. 4 illustrates an exemplary appliance according to disclosed implementations.

FIG. 5 illustrates exemplary network communication paths between components according to disclosed implementations.

FIG. 6 illustrates exemplary network communication paths between appliances according to disclosed implementations.

### DETAILED DESCRIPTION

Reference will now be made in detail to implementations, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular implementations described herein are provided by way of example and should not be used to limit the scope of the invention to these particular implementations. In other instances, well-known data structures, timing protocols, software operations, procedures, and components have not been described in detail so as not to unnecessarily obscure aspects of the implementations of the inventions.

Introduction

The ability to manage, analyze and understand information is fast becoming a competitive differentiator. Organizations that can't harness the computing power to understand data will find they can't achieve innovative breakthroughs, service customers, or expand globally. Private clouds have been identified as an approach for creating the elasticity, storage, and security needed for managing data, but the cost and complexity (and immaturity) of private cloud technology has prevented many enterprises from taking advantages of these benefits.

Private Clouds

The disclosed implementations describe novel approaches to private cloud computing that, for example, remove the financial and technical barriers preventing enterprises from gaining significant breakthroughs and insights from data. Three converging trends promise to make private cloud adoption a reality.

Trend 1: The Data Explosion

Enterprises are experiencing an exponential growth of business data. Storage and compute power can't keep up with the growth rates. According to McKinsey, by 2009, “nearly all sectors in the U.S. economy had at least an average of 200 terabytes of stored data (twice the size of U.S. retailer Wal-Mart's data warehouse in 1999) per company with more than 1,000 employees.” (“Big data: the next frontier for innovation, competition, and productivity,” McKinsey & Company, May 2011. Social networks like Facebook and Twitter manage billions of pieces of data uploaded by members, with increasingly high expectations for this data's availability. This data explosion—driven in part by the proliferation of digital devices and big data-centric research—is spawning new analytic tools, processes, and platforms that are pushing the computing infrastructure to its limits in performance.

The explosive growth of data is largely good news for organizations, as there is a wealth of information to be gleaned from it. Organizations can use data to spot business trends, detect criminal activity, and solve small problems before they become major, profit-damaging crises.

However, too much data is a business disabler, not a business enabler. Enterprises are becoming so overrun with data that they can't parse it for valuable insights, and they don't have room to store it, much less process it.

Trend 2: Information Technology as a Service

Enterprises are looking for ways to maximize efficiency in every part of the business, and IT is no exception. Instead of simply providing technology services, IT departments must share in overall business goals of managing costs, meeting compliance requirements, assuring availability of services—and overall, adding value to the business. Specifically, enterprises rely on IT services to help them meet demands for business agility.

To meet business agility goals, as well as the need to create elastic compute, storage and network services, IT departments look to cloud services to help them supplement their capabilities. For example, cloud utilization improves efficiency and operations, reduces costs, and increases opportunities for growth.

Other technology trends feed into the IT as a Service imperative. Enterprises manage exponentially more applications and configuration medications when private clouds are put into place. According to Gartner, RFCs (requests for change) can rise from 2,000 per month to 70,000 per month, and applications in production can rose from 200 to 3,000 once organizations adopt private clouds. “Change volume will increase with dynamic change demands as a result of commitments to service-oriented architecture (SOA),” according to Gartner. “As the IT organization evolves into a service provider, demonstrating business value will be easier as the focus on change and configuration continues.” (“Best Practices in Change, Configuration and Release Management,” Gartner, July 2010.)

The disclosed implementations provide an architectural breakthrough needed to resolve the cost, complexity, and performance challenges of implementing and operating private clouds. Industries as varied as financial services, biotechnology, and energy can address their biggest data processing challenges at dramatically reduced costs and with far simpler technologies. The result is greater access to the wealth of knowledge and discoveries to be found within ever-increasing data.

Trend 3: Open Source and Commodity Scale-out Architectures

The move toward open source software has caused enterprises to look more closely at the development of their own private clouds. As the software services layer, and storage itself, become commoditized, web companies—out of necessity—built their own architectures on commodity hardware that scaled out cheaply. Market leaders such as Facebook and Google have taken this approach, stringing together commodity machines and writing their own applications in an effort to gather the compute power and storage needed. A substantial advantage of open source and commodity scale-out architectures are that they allow for inexpensive scale-out of cloud systems.

Private Cloud Issues

While the above trends are bringing about greater adoption of private clouds, some issues to their implementation still exist. A few of the examples of such issues are found below.

Issue 1: Scale-Out Proven

Extremely large companies working with massive amounts of data have shown that they can create private clouds with nearly unlimited storage and elasticity. However, this kind of endeavor tends to be limited to enterprises with very large IT budgets and staff. Private clouds usually require the complex and expensive implementation of servers and storage solutions, all of which can create compatibility and integration problems. To solve these problems, companies must buy the services of expensive consultants to make sure all the components for their cloud solution work together to create the necessary computing platform. The skills required to perform system integration, development, and testing on this level are highly specialized, and are usually not available in house—hence the need for outside consultants.

Issue 2: Compute and Storage is Lagging

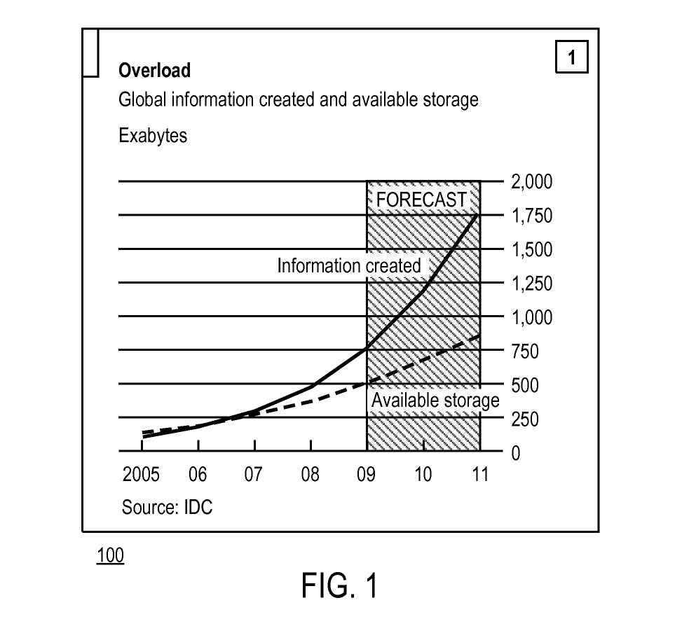

Data is growing faster than private cloud storage capabilities. As shown in FIG. 1 below, The Economist reports that according to IDC, global data will reach 1,750 exabytes by the end of 2011, while available storage is projected to reach only 750 exabytes.

Issue 3: Brittle and Prone to System Failure

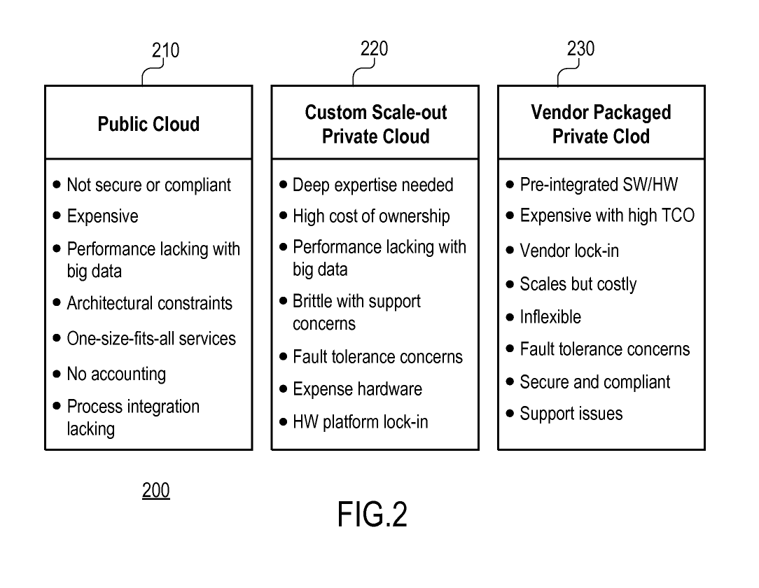

Systems can be temperamental, and are as unstable as their weakest element. System failure is always a threat. Companies can attempt to build fault tolerance into their private clouds, but when servers fail, replacement costs are high and data can be unavailable for hours. FIG. 2 illustrates the pros and cons of public vs. private clouds.

Open Source and Commodity Scale-out Architectures

The move toward open source software has caused enterprises to look more closely at the development of their own private clouds. As the software services layer, and storage itself, become commoditized, web companies—out of necessity—built their own architectures on commodity hardware that scaled out cheaply. Market leaders such as Facebook and Google have taken this approach, stringing together commodity machines and writing their own applications in an effort to gather the compute power and storage needed.

Architecture Overview

The foundation of the disclosed implementations are a hardware appliance and method of using that appliance that may be configured to be coupled with commodity server nodes to provide a fault tolerant and available private cloud. This cloud controller appliance can provide a system to deploy a private cloud within an enterprise. Multiple appliances can be used together to create a distributed control plane and a more highly available (HA) private cloud.

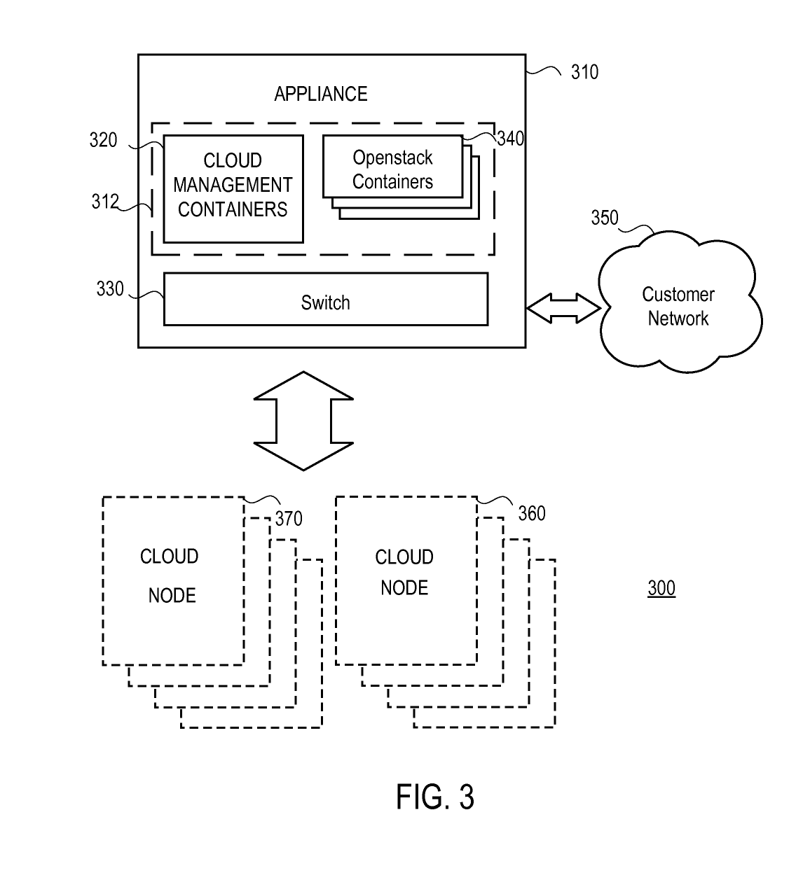

FIG. 3 illustrates a big picture example of a zone 300 made up of, in this example, one appliance 310, with its own host 312 and switch 330. The appliance 310 communicates with an external network 350. The appliance 310 also communicates with cloud nodes 360 and 370. This FIG. 3 is merely one example embodiment. The numbers of the appliances, cloud nodes and external networks could be any number.

Internal to the example appliance 310 is a host 312 and a switch 330. The host 312 runs a series of cloud management software containers 320 and a set of OpenStack containers 340. The Switch 330 is configured to communicate with an external customer network 350 and the cloud nodes, shown as examples 360 and 370.

Zone

In FIG. 3, only one appliance 310 is shown connected to two cloud nodes 360 and 370 and an external customer network 350. In this example, this grouping is called a zone 300. This arrangement is an example only, and any number of appliances, each with their associated cloud nodes, and in communication with an external customer network, to work together in a zone 300.

The zone 300 is an abstraction around a set of appliances that are in communication with one another. A cloud could be made up of one or more than one zone 300. Within a zone, a single appliance can be used. However, to ensure high availability (HA) a constellation approach with multiple appliances is required. Traditional Linux-HA technologies can be used (e.g. Heartbeat/Pacemaker) and floating Internet Protocol (IP) addresses can be used to represent a zone. These embodiments will be described later in this disclosure.

OpenStack

In this description, the term “OpenStack” is used to describe an open source platform and is used as the software basis for the private cloud for this example. Wherever in this disclosure, the term “OpenStack” is used, it may be substituted for later embodiments of similar platforms used as the software basis of any cloud computing network. Later embodiments that accomplish similar things could be substituted for the term “OpenStack” throughout this disclosure.

OpenStack may be difficult to deploy effectively. As described herein, the disclosed embodiment utilizes a hardware appliance (or multiple appliances) to simplify the deployment of OpenStack effectively and efficiently to implement and manage private clouds, thereby eliminating the complexity of configuring and deploying an OpenStack private cloud. The appliances described herein are configured to be adaptable to existing systems and can be used in a “plug and play” fashion, and utilize commodity server nodes to provide the processing workload, storage solutions and additional features as described herein. FIG. 3 illustrates an exemplary network configuration for implementing a private cloud according to the disclosed embodiment.

Services for operating the private cloud can be contained within the appliances as software containers. These could include, but are not limited to, a Management and Provisioning Dashboard, OpenStack Compute network management (IPAM, DNS, DHCP), OpenStack Compute API, OpenStack Image Registry API, OpenStack Storage API, OpenStack Identity Management, Compute and Storage Provisioning API, a DatabaseService and Queuing infrastructure, Log aggregation and shipping, Health monitoring, and Service load balancing.

Cloud Nodes

The switch 330 in the appliance 310 is configured to communicate with any number of cloud nodes. This example in FIG. 3 shows two cloud nodes, 360 and 370. Cloud nodes described here may be any commodity server that is configured with an appropriate hardware configuration for the intended workloads and storage needs. Suitable Cloud Node servers include, for example, OpenCompute, Dell, HP, IBM, etc. but others may work as well. The cloud nodes are used to store running virtual machines for live migrations. The nodes can also be used to create block devices that can be attached to running virtual machines for more permanent and reliable storage.

Constellation Approach

The appliances of the disclosed embodiment can be applied singly or, more preferably, in groups. In FIG. 3, only one appliance 310 is shown. However, there could be any number of appliances networked together. When these appliances are networked together, they can be grouped in a zone as described elsewhere in this disclosure. As more appliances are added to a logical zone of a private cloud, performance increases and the services become more fault tolerant. Thus, as more appliances are added to a “constellation,” the redundancy, fault tolerance, and performance of the system as a whole scales linearly.

Cloud Management Containers

Further, in the FIG. 3 example embodiment, cloud management containers 320 are shown within the appliance 310 host 320. These cloud management containers 320 are used to facilitate management of the appliances and other components and software containers within the cloud or the zone. Utilizing extensible management tools allows for management in a hybrid environment, often with customizations that are unique to each individual deployment. The management containers 320 can include a web-based user interface, which manages each connected device and provides the current status of each device within the system.

The Cloud Controller Appliance

The appliance can be a member of a zone, and can have its own IP independent of the zone IP (even if it is currently the zone controller/master). Appliance level operations will primarily revolve around functions such as provisioning the individual components that make up the appliance, such as:
container_create(container_name) # eg_create(DatabaseService), which creates a DatabaseService container and configures it;
container_status(container_name);
container_list( ) etc.

These operations exist primarily to get information from a command line interface or a web interface so very detailed information can be obtained about the state and health of each appliance and the containers within.

Organization by Container

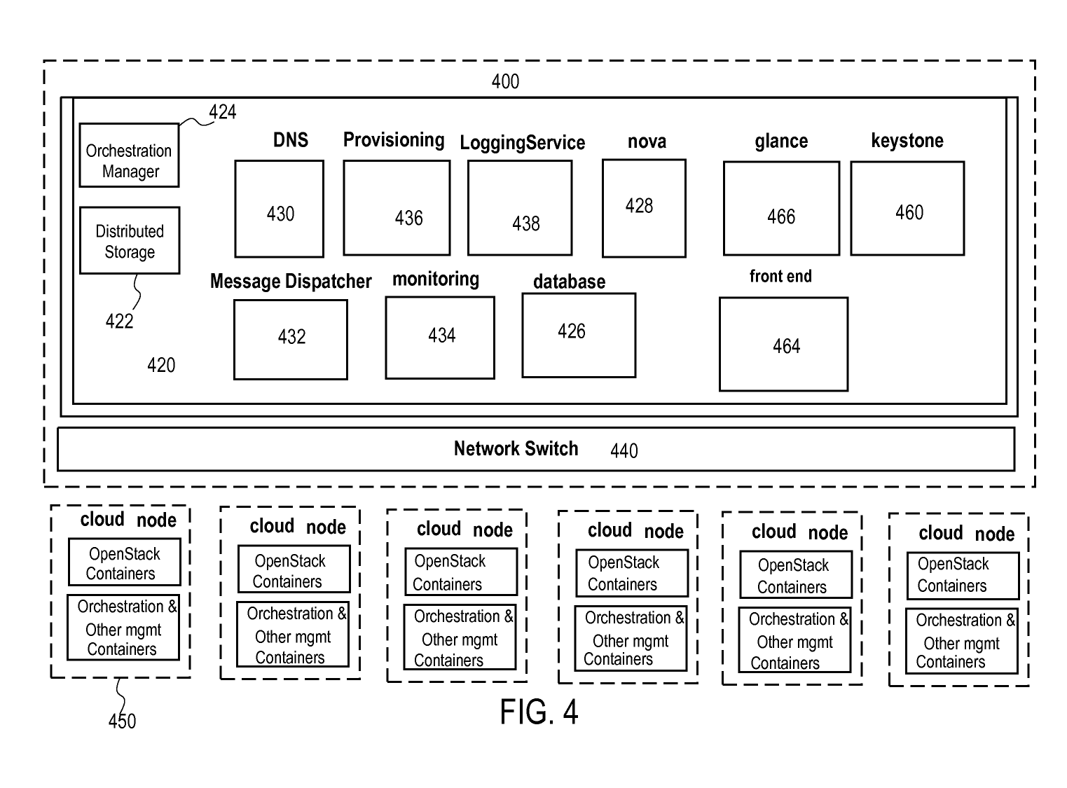

FIG. 4 is a detail of the appliance of FIG. 3 and its associated cloud nodes. As is shown in FIG. 4, each appliance 400 described herein can include a host 464 running various software containers, and a switch 440 as described here. Each container may have custom operations such as configure, restart, shutdown, etc.

Host

The host 420 runs, for example, many software containers. Some containers may be used to manage the appliance and the cloud, such as, for example, the OrchestrationManager 424 which exposes APIs to control the zone, appliance and containers, DatabaseService 426, and DistributedStorageService 422. Other containers may be used for other purposes. They could be any variety of software container and some examples may include the following:

The ProvisioningService container 436 is configured to facilitate bare-metal orchestration of nodes attached to the appliances, boot strap operating system configurations, and configure and create each individual service container inside the appliance.

The ProvisioningService container 436 is software used for bare metal orchestration. It is configured to take an operating system image and apply it over the network to a compute or storage node using standard protocols, such as the PXE protocol. ProvisioningService 436 also could provide IP address management via DHCP. The operating system images can be shared among a group of appliances by using the DistributedStorageServices 422.

The MessageDispatcher container, as described herein, is an HTTP based message dispatching system, which can be used to service API requests using management dashboard and command line interface tools and provide a bridge between the system administrator and the OrchestrationManager software.

The DatabaseService container 426, which provides a highly available database that can used by other appliance services to storage state and configuration information. The database sits on top of the DistributedStorageServices, enabling rapid failover and replication capabilities.

The LoggingService 438 container provides logging capabilities via systems like rsyslog, as well as log shipping capabilities to systems outside the private cloud. It also provides an uplink to many standard security and operations software, such as ArcSite and Splunk.

BalancerService container 432, is configured to be a load balancer. The balancer component could be implemented using technologies like HAProxy. BlanacerService 432 can provide an SSL termination front end to each request to the various web based APIs such as nova-api, glance-api, etc. BalancerService can provide intelligent load balancing capabilities to these API services, allowing performance and reliability to scale as more appliances are added.

MonitoringService container 434, is configured to be a service configured to monitor loads, etc. The monitoring component could include technologies such as Nagios and Ganglia. MonitoringService provides event based alerting in case of a number of common hardware or service failures, and allows system administrators to be alerted to changes in the health of their deployment. MonitoringService provides real time and historical system level metrics monitoring, allowing a real time view of CPU usage, disk I/O, network I/O, and more.

DashboardServices container 464, is configured to provide both an administrative and an end user facing web based dashboard. The DashboardServices 464 provides system administrators a way to view the high level configuration and operational status of their private cloud. The DashboardServices provides end users many functions to manage their individual cloud applications, such as a way to monitor their running virtual instances, access their object store, and manage their virtual machine images.

The last containers in this example are part of OpenStack. They are the glance container 466, keystone container 460 and Nova container 428. Other OpenStack containers can be used here, or less, depending on the circumstances. Further, besides OpenStack, some other similar type of containers could be run in their place.

In this example, Glance container 466 (part of OpenStack), is configured to be a virtual machine image store. This container is configured to allow users of the system to take snapshots of their running virtual machines and upload them, allowing them to rapidly provision many instances of that image as desired. The Glance component includes glance-api and glance-registry. Glance-api is an HTTP based API front end to this service, and glance-registry is the core component that stores and retrieves the virtual machine images.

Keystone container 460 (part of OpenStack), can be configured to provide an abstraction identity management system. This container can be configured to serve as a common authentication and authorization front end. This component includes keystone-api, which is an identity management front end to many common authentication systems, such as LDAP, Kerberos, and ActiveDirectory. This can allow customers to use their existing identity management systems with the OpenStack services.

Nova container 428 (part of OpenStack), which provides supplemental services that assist and/or control nodes. The Nova 428 component includes nova-network, nova-scheduler, and QueueServices. Nova-network provides IP address management and DHCP services for the nodes. Nova-scheduler receives virtual machine provisioning requests from the Nova API and intelligently chooses a compute host based on load and other factors. QueueServices provides queue based message communications for all of the various Nova compute services, allowing scalable communications across a zone.

Switch

The switch 440 of the appliance 400 is configured to communicate with the various cloud nodes 450 and the external network (not pictured). Any suitable type of network switch 440 may be used in the appliances as the network switch 440. This can provide high speed and redundant network connectivity to all of the nodes connected to the appliance.

Cloud Nodes

The example in FIG. 4 depicts a number of cloud nodes in communication with the switch 440 of the appliance 400. Any number of cloud nodes 450 could be used by one appliance 40. And any type of server may be used for the cloud nodes 450. As described herein, an exemplary node will include nova-compute and DistributedStorageServices components. Nova-compute 428 is the service that provides a bridge between Nova API requests and the hypervisor on the compute node itself. This service receives messages from nova-api via the nova-scheduler and instructs the hypervisor to create, terminate, or migrate virtual machines. The DistributedStorageServices are used to store running virtual machines for easy live migrations. The DistributedStorageServices is also used to create block devices that can be attached to running virtual machines for more permanent and reliable storage.

Cloud nodes 450 can also provide a scalable, reliable object store. This allows users to read and write objects over an HTTP interface, or to mount their object store directly on running virtual machines as a standard POSIX file system. These capabilities are provided by the DistributedStorageServices made up of all the nodes in a zone. As described herein, an exemplary node providing object storage will preferably include rsync, swift-account, swift-object, swift-container, swift-container-updater, swift-account-auditor, swift-object-replicator, swift-container-replicator, swift-container-auditor, swift-account-replicator, swift-account-reaper, swift-object-updater, and DistributedStorageServices components.

The appliance host O/S preferably has the following logical services, but may have others or less, depending on the circumstances: DistributedStorageService 422 (shared storage across the zone), which provides storage for the DatabaseService, QueueService, log files, and anything else that requires shared storage heartbeat/crm, which provides master/standby, manages floating ip, and provides logical zone controller, and OrchestrationManager 424, which provides the management and provisioning capabilities.

Network connectivity

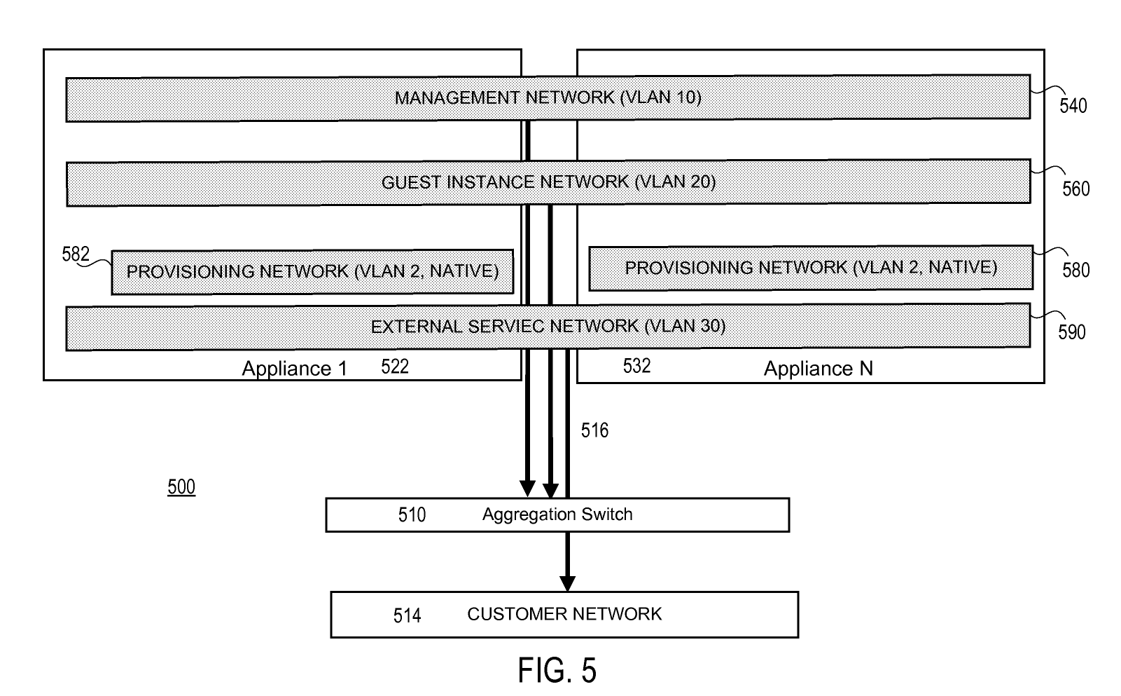

The appliances in this example are configured to communicate with an external network. This could be a customer network or any kind of computing network may be utilized to implement the systems described herein. An exemplary illustration of suitable network connectivity is shown in FIG. 5.

FIG. 5 illustrates an example of how the network may connect the components of the private cloud described here. Here, Virtual Local Area Networks (VLANs) are used to connect any of the internal containers (not depicted). Through these VLANs, containers can be isolated, communicate to the external networks, communicate with other containers, and communicated down the rack, etc.

The FIG. depicts racks, rack 1, 522 up to any number of racks, here depicted by rack “n,” 532. These racks are connected by management networks 540, guest instance network 560, and an external services network 590. Each rack, rack N 532 and rack 1 522 has its own provisioning network 580 and 582 respectively. Through these networks, the racks are connected to an aggregation switch 510 and a customer network 514 via a VLAN tunnel 516.

The IP range for the management network (VLAN 10) 540 example shown here is 172.17.0.0/12. The IP range for the guest instance network (VLAN 20) 560 example shown here is 10.16.0.0/12. The IP range for the provisioning network (LCAN 2, Native) 580 example shown here is 192.168.200.0/24. The IP range for the external services network (VLAN 30) 590 example shown here is customer defined.

High Availability Design

By utilizing a “Constellation” approach of networked appliances, the disclosed embodiment makes it possible to turn racks of commodity servers into an orchestrated constellation of nodes operating in union which operating at a cost that significantly lower than other private cloud solutions.

Each container in the appliance may consume multiple IP address to facilitate communications (for example, 10 IP addresses). Global High Availability mechanisms may utilize additional IP addresses (for example, 7 global (floating) IP addresses) for clustering resources—1 for the appliance/zone master, 6 for internal containers.

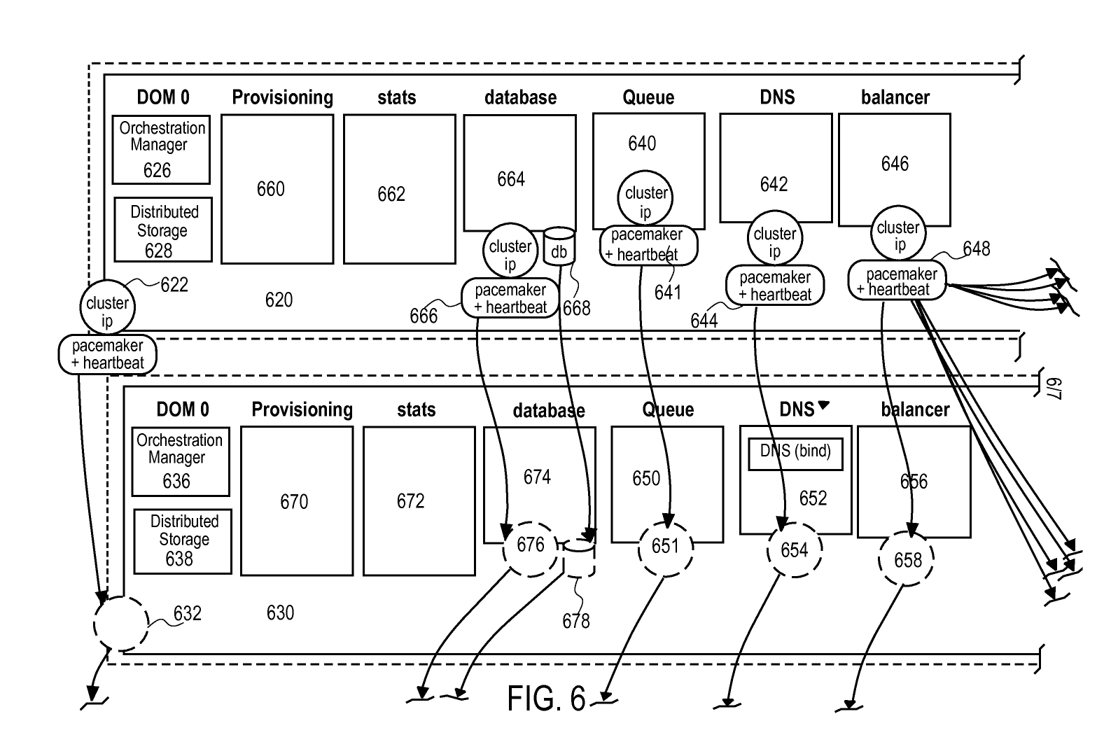

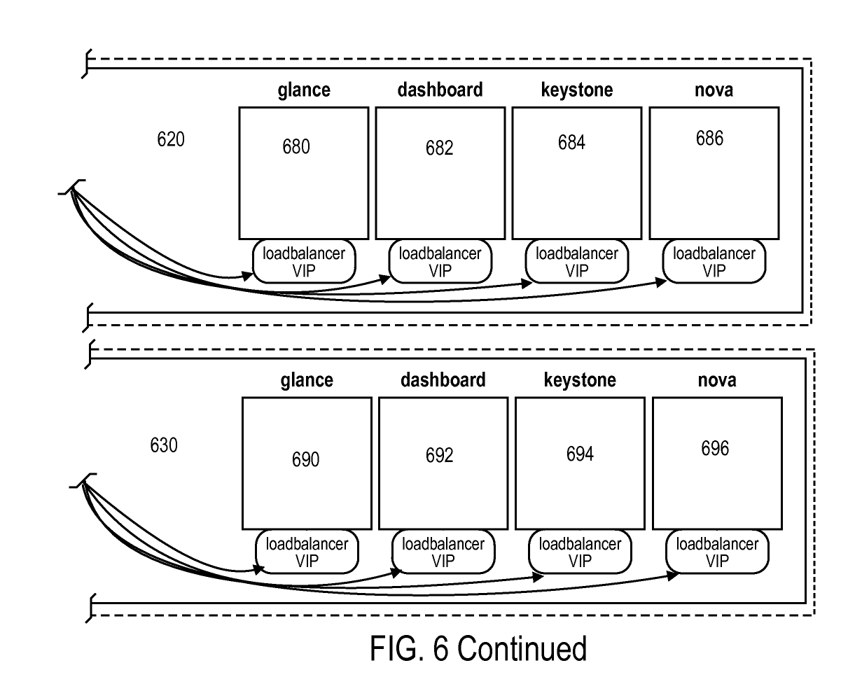

FIG. 6 illustrates an exemplary configuration of the high availability (HA) design of the system. FIG. 6 is split into two portions but the lines are to flow across the pages and are indicated so by the breaks. FIG. 6 shows another embodiment of the appliance shown in FIG. 4, but with lines of communication connecting the component containers that communicate within and among the various appliances that may be connected to it. And containers within there appliances In this way, more than one appliance can be networked together and increase the capabilities of the system.

Specifically, FIG. 6 depicts a series of appliances depicted here by showing just two, 620 and 630. It is to be assumed that any number of these could be connected in a likewise manner.

The HA aspect, or redundancy aspect, of the cloud as described here, is that containers within the appliance that are cloud specific (as opposed to individually appliance specific) need redundant backup. Backup, creates HA by linking appliances and ensuring that if one cloud specific container dies, or malfunctions, another similar container is available to pick up the load. In this way, appliances back up one another as their internal containers back up the other appliance containers within the zone.

“Heartbeat” and “Pacemaker” communication

Within the “constellation” of appliances, for example in a zone, each appliance is capable of communicating with every other appliance within the zone or cloud. Specifically, appliances that are coupled together within the cloud utilize “heartbeat” signal transmission to check on the status of other appliances and devices to ensure each is operating properly and to check for malfunctions. To better facilitate the use of “heartbeats,” the containers are preferably assigned master or slave roles within the “constellation” to most efficiently service requests.

Appliances may be assigned floating IP addresses between them to be utilized during “heartbeat” communications. For the data replication of DatabaseServices persistence, database master/slave configurations can be used with data replication.

An example in FIG. 6 of a cloud specific container is anything with an associated “cluster ip, pacemaker +heartbeat” symbol next to it, such as the database 664, the queue 640, the DNS 642 and the balancer 646. An example of appliance specific container is the provisioning container 660 or the logging container 662. These do not show an associated “cluster ip, pacemaker +heartbeat” symbol because they are not configured to be highly available like the cloud specific containers.

The entire appliance 620 is also configured to be connected via a cluster ip and a pacemaker +heartbeat monitor 622 to the next appliance 630 and their respective cluster ip and pacemaker +heartbeat monitor 632. In this way, the appliances can practice HA as well.

For this example, the floating IP used to represent the zone is 172.24.1.1. By using the IP zone level management capabilities can be exposed such as: provision_cloud_node(mac_address, etc) # add a new cloud node to the private cloud; register_controller(ip) # add a new CloudController appliance to the zone; and register_zone(zone_ip) # enable inter-zone communications.

The list shows, for example here, that none of the functions are special to any one appliance. Any of the appliances can serve these requests, but for logical reasons, only the current master that has 172.24.1.1.

The backup is run by the appliance orchestration managers 626 and 636. Each orchestration manager 626 and 636 has an associated distributed storage system 628 and 638 respectively. The cloud specific containers each signal the orchestration manager 626 their “health” through the “cluster ip, pacemaker +heartbeat” system. “Health” of a container can be thought of as the properly operating capabilities of that particular container. If the container is functioning as it was intended to function, it has good “health.” If it does not, it has poor health and may need to be replaced by the orchestration manager 626. In this case, the orchestration manager 626 would designate a new container which serves the same function, in another networked appliance.

For example, as shown in FIG. 6, if a cloud specific container becomes unhealthy, such as the database container 664, the orchestration manager 626 of the first appliance 620 communicates with another appliance 630. The associated container that needs replacing, here the database container 664, will be replaced by the redundant database container 674 in the subsequent appliance 630. In the example of the database container, the associated database itself 668 also will be replaced by its redundant backup 678. The “cluster ip, pacemaker +heartbeat” system goes with it to report to its associated orchestration manager 636 of its health.

In this way, all containers that are utilized throughout the zone, and/or the cloud can be made highly available. The queue 640 by its backup 650. The DNS 642 by its backup 652. The balancer 646 by its backup 656. The same is true for their respective “cluster ip, pacemaker +heartbeat” systems, 676, 650, 654 and 658. And by using more than just the two appliances shown here, the HA could stretch into any number of appliances for more redundant capability.

Load Balancing

The balancer container 646 of the first appliance 620 is configured to communicate with a number of other containers. But unlike the HA backup system for the cloud level specific containers, the load balancer is used to shuffle and balance loads to any and all OpenStack containers available. This is done with the “health” of the containers in mind, but also with many other factors as well. In this example, the load balancer balances loads to containers in an OpenStack system. This is merely an example and any kind of container could be used in their place to do what the OpenStack system does.

The OpenStack containers shown in the appliance examples are glance container 680, the dashboard container 682, the keystone container 684 and the nova container 686. But unlike the HA system, in which the Orchestration Manager calls on redundant containers in another appliance to replace a broken or unhealthy container, here, the load balancer 646 calls upon any number of OpenStack containers in order to accomplish tasks. These could be located in the same appliance, such as the glance container 680, the dashboard container 682, the keystone container 684 and the nova container 686, or they could be located in another appliance, such as 630's set of the glance container 690, the dashboard container 692, the keystone container 694 and the nova container 696.

Thus, as shown in FIG. 6, the balancer container 646 can send loads to any and all of these containers in any manner that it is designed to do. Thus, the lines connecting the load balancer 646 to all of these OpenStack containers runs to them at the same time. Any of the representative lines of communication could be used to send loads.

The load balancers are still part of the overall HA system too. Thus, the balancer container 656 in another appliance such as appliance 630 is only used if the master or original load balancer 646 has poor health and the orchestration manager 626 receives that information from the balancer “cluster ip, pacemaker +heartbeat” system 648. In that case, the balancer in the subsequent appliance, here 656 would pick up the balancing task and begin balancing the loads to any and all of the OpenStack containers in any appliance as above. That replacement balancer 656 would also send its health information via its “cluster ip, pacemaker +heartbeat” system 658 to its orchestration manager 636 to ensure redundancy and HA.

Growth

The disclosed approach can allow organizations to build, and expand upon, their cloud infrastructure by removing the complexity normally involved in such a deployment. Services can be configured internally for fault tolerance and fail prevention. By using a shared storage system internally, I/O speed to and from each appliance increases as more appliances are added and the constellation is grown.

In addition, by utilizing the “constellation” approach, the cloud environment is scalable, and capable of growth. Specifically, the system of the disclosed embodiment has the capability to expand from a small system of a few nodes to many nodes and provide a non-blocking fabric across the entire cloud.

Fault tolerance

Fault tolerance may be important in a cloud environment. By utilizing a “constellation” approach and the above-described “heartbeats” between appliances, the systems of the disclosed embodiment are fault tolerant. By linking groups of appliances together to form a single cloud, faulty appliances or other components can be identified, isolated, and possibly even removed from the system. In the event of a fault, the functions of the faulty appliance or component can be assumed by another device in the “constellation.” In addition, each function can be replicated by multiple appliances in the “constellation,” thereby helping prevent a system crash and other problems if a single appliance or other component fails for any reason. Furthermore, the expandability of the “constellation” could make it easy to add low-cost compute or storage nodes or devices into the racks of an existing system (i.e. into an existing “constellation”), or even replace a rack of servers as they fail.

Self-repair

By utilizing the “constellation” approach and the above-described “heartbeats” between appliances, it can be diagnosed if one or more appliances or other components become faulty or perform incorrectly. If this occurs, any of the other appliances can preferably repair the faulty appliance or component, and if necessary, rebuild it to its original (or a subsequently modified) state.

Quarantine

Furthermore, if there is a breach in security at one or more appliances or other components, the breached appliances or components can quickly be quarantined, and the functions of those appliances and components can be assumed by other devices in the cloud.

Exemplary Hardware Variations

As described herein, the above embodiments implemented with any combination of hardware devices and software, for example modules executed on computing devices. Devices and components described herein illustrate various functionalities and do not limit the structure of any embodiments. Rather the functionality of various devices and components may be divided differently and performed by more or fewer devices and components according to various design considerations.

Devices described herein may include one or more processing devices designed to process instructions, for example computer readable instructions (i.e., code) stored on storage devices. By processing instructions, processing devices may perform the steps and functions disclosed herein. Storage devices may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the Internet. Computing devices additionally may have a memory, an input controller, and an output controller. A bus may operatively couple components of computing devices and appliances, including a processor, a memory, a storage device, an input controller, an output controller, and any other devices (e.g., network controllers, sound controllers, etc.). An output controller may be operatively coupled (e.g., via a wired or wireless connection) to a display device (e.g., a monitor, television, mobile device screen, touch-display, etc.) in such a fashion that the output controller can transform the display on the display device (e.g., in response to modules executed). An input controller may be operatively coupled (e.g., via a wired or wireless connection) to an input device (e.g., mouse, keyboard, touch-pad, scroll-ball, touch-display, etc.) in such a fashion that input can be received from a user.

Of course, computing devices, display devices, and input devices are described as separate devices for ease of identification only. Computing devices, display devices, and input devices may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing devices may be one or more servers, for example a farm of networked servers, a clustered server environment, or a cloud network of computing devices.

Embodiments have been disclosed herein. However, various modifications can be made without departing from the scope of the embodiments. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system configured to operate a private cloud computing network comprising:
one or more hardware appliances each having at least one host and at least one switch;
wherein the at least one host is configured to run at least one software container; and
wherein the at least one switch is configured to communicate with at least one server node and configured to communicate with at least one external network,
wherein the one or more appliances are configured to maintain operation/availability of the cloud network.

2. The system of claim 1 wherein the one or more containers is selected from the list comprising:
a provisioning container, a logging container, a database container, a queue container, a DNS container, and a load balancer container.

3. The system of claim 1 wherein the one or more appliances are grouped in one or more zones, the zones defining a cloud computing system,
wherein the appliances in the zone are configured to be in communication with one anther over one or more of the following virtual local area networks: a management network, a guest instance network, and an external network, and
wherein the appliances in the zone are configured to communicate to nodes internally via a provisioning network.

4. The system of claim 1 further comprising a web-based user interface which is configured to manage each connected device and provide the status of those connected devices.

5. The appliance of claim 1 wherein the at least one container is an OpenStack container configured to run and/or manage the cloud network.

6. The system of claim 1 wherein the configuration to maintain operation/availability of the cloud network comprises monitoring the at least one appliance other via a heartbeat system and an orchestration manager,
wherein the heartbeat system includes one or more components configured to communicate and/or perform status checks between appliances and/or containers and the orchestration manager to ensure proper operation.

7. The system of claim 6 wherein the one or more appliances each have the same containers for redundancy.

8. The system of claim 1 wherein at least one of the one or more containers is an orchestration manager configured to:
monitor the at least one appliance and the at least one container via the heartbeat system; and
designate another container in a networked appliance, or another appliance, if the heartbeat system indicates the container or appliance is malfunctioning.

9. The system of claim 8 wherein one of the one or more containers in the host is a load balancer configured to balance loads across one or more containers from the one or more appliances.

10. The system of claim 1 wherein the at least one switch is configured to communicate with the at least one cloud node regarding at least one of the following tasks taken from the list of: virtual machine, storage, and computation; and
send data to and receive data from at least one external network.

11. A computer implemented method for operating a private cloud computing network system comprising:
in at least one hardware appliance:
receiving data requests, via at least one switch, from an external network;
processing the received data requests in at least one or more software containers;
sending cloud node data requests, via at least one switch, to at least one cloud node;
receiving cloud node data, via at least one switch, from at least one cloud node;
processing the received cloud node data in the at least one or more software containers;
sending the processed data to the external network in response to the received data request,
wherein the at least one appliance is configured to communicate with another appliance.

12. The method of claim 11 wherein the at least one appliance is two or more networked appliances configured for redundancy, and
wherein the redundancy includes hosting redundant containers in order to take over container tasks.

13. The method of claim 12 wherein the back up includes an orchestration manager container configured to communicate with all of the networked appliance containers via a heartbeat system,
wherein the orchestration manager container designates at least one redundant container in any networked appliance, to take over for at least one container that the heartbeat system indicates is malfunctioning.

14. The method of claim 11 wherein the at least one container is a load balancer configured to assign tasks to at least one container,
wherein the at least one container is hosted in either the same appliance as the load balancer, or another, networked appliance.

15. The method of claim 11 wherein the at least one container is an OpenStack container configured to manage the cloud network.

16. The method of claim 11 wherein at least one of the containers is an orchestration manager container is configured to:
receive heartbeat information from the at least one container;
process the received heartbeat information; and
designate at least one other container to replace a container if the heartbeat information indicates that the container is malfunctioning,
wherein the at least one other container is found in any of the networked appliances.

17. The method of claim 11 wherein the networked appliances communicate via one or more of the following virtual local area networks:
a management network;
a guest instance network; and
an external service network,
wherein each appliance communicates internally via a provisioning virtual local area network; and
wherein the networked appliances are configured to communicate with an external network via an aggregation switch.

18. A system configured to operate a private cloud computing network comprising:
one or more of components and/or hardware appliances configured to:
receive data requests, via at least one switch, from an external network;
process the received data requests in at least one or more software containers;
send cloud node data requests, via at least one switch, to at least one cloud node;
receive cloud node data, via at least one switch, from at least one cloud node;
process the received cloud node data in the at least one or more software containers;
send the processed data to the external network in response to the received data request,
wherein the at least one appliance is configured to connect with at least one other appliance.

19. The system of claim 18 wherein at least one of the containers is an orchestration manager container, configured to manage redundancy of the at least one container using a heartbeat system,
wherein the heartbeat system comprises communications between the at least one container and the orchestration manager container regarding container performance, and
wherein the orchestration manager is configured to replace a malfunctioning container with another container found on another appliance.

20. The system of claim 18 wherein at least one of the at containers is a load balancer, configured to balance loads across any container in any of the networked appliances.
